(19) United States
(12) Patent Application Publication
(10) Pub. No.: US 2005/0156830 A1
(43) Pub. Date: Jul. 21, 2005

(54) Image display apparatus and inspection method thereof

(75) Inventor: Youichi Tobita, Hyogo (JP)

Correspondence Address: McDermott, Will & Emery LLP, 600 13th Street, N.W., Washington, DC, 20005-3096, US

(73) Assignee: MITSUBISHI DENKI KABUSHIKI KAISHA

(21) Appl. No.: 10/919,466

(22) Filed: Aug. 17, 2004

(30) Foreign Application Priority Data
Jan. 7, 2004 (JP) 2004-001882(P)

(51) Int. Cl. G09G 3/30

(52) U.S. Cl. 345/76

(57) ABSTRACT

This pixel display circuit includes an EL drive circuit including serially connected EL element, a P-type transistor and a resistor element, a differential amplifier circuit setting a potential of the gate of P-type transistor such that a potential of a control node becomes equal to a potential of an input node, and an offset compensation circuit canceling an offset voltage of differential amplifier circuit. Accordingly, the factor of variations of the value of a current flowing through EL element becomes only a resistance value of resistor element, and therefore variations of display characteristics among pixels are reduced.

### BACKGROUND OF THE INVENTION

1. Field of the Invention

The present invention relates to an image display apparatus and an inspection method thereof, and particularly, to an image display apparatus having an electric field light-emitting element such as an electroluminescence (hereinafter referred to as EL) element, and an inspection method thereof.

2. Description of the Background Art

According to a conventional EL display apparatus, in each pixel, a drive transistor and an EL element are serially connected between a line of power supply potential and a line of ground potential, and an access transistor is connected between a data line and the gate of the drive transistor. A potential according to display data is provided to the gate of the drive transistor via the data line and the access transistor, and the current having a value according to that potential is allowed to flow through the drive transistor and the EL element. The EL element emits light at a light intensity according to the current value (See, for example, Japanese Patent Laying-Open No. 2001-100656).

When the drive transistor is formed with a polycrystalline silicon thin film transistor in such an EL display apparatus, characteristics (threshold voltage, mobility) of the drive transistor vary relatively largely, and the current flowing through the EL element varies accordingly. Therefore, there is a problem that the displayed colors are different among a plurality of pixels even when an identical potential is applied to the pixels, and in special, that variations of colors are noticeable between adjacent pixels.

### SUMMARY OF THE INVENTION

Therefore, a main object of the present invention is to provide an image display apparatus and an inspection method thereof, in which variations of display characteristics among pixels are small.

An image display apparatus according to the present invention is an image display apparatus displaying an image in accordance with an image signal including: a plurality of pixel display circuits arranged in a plurality of rows and columns and each including an electric field light-emitting element;
a plurality of data lines provided corresponding to the plurality of columns, respectively; a vertical scanning circuit successively selecting the plurality of rows each for a prescribed time period synchronizing with the image signal; and a horizontal scanning circuit providing each of the plurality of data lines with a potential according to the image signal while one row is selected by the vertical scanning circuit. Here, each of the pixel display circuits includes: a drive circuit including a first transistor serially connected to a corresponding electric field light-emitting element between a line of a first potential and a control node, and a resistor element connected between the control node and a line of a second potential, and allowing a current having a value according to a potential of the control node to flow through the corresponding electric field light-emitting element; a differential amplifier circuit activated in accordance with a selection of a corresponding row by the vertical scanning circuit and setting a potential of a control electrode of the first transistor to allow a potential of the control node to be equal to a potential of an input node; and an offset compensation circuit activated in a time period during which the differential amplifier circuit is activated to detect an offset voltage of the differential amplifier circuit, providing the input node of the differential amplifier circuit with a potential obtained by adding the detected offset voltage to a potential of a corresponding data line, and canceling the offset voltage of the differential amplifier circuit.

Additionally, an inspection method of the image display apparatus according to the present invention is an inspection method for inspecting the image display apparatus described above, including the steps of: providing a data line corresponding to a pixel display circuit of an inspection target with a test potential; activating a differential amplifier circuit and an offset compensation circuit of the pixel display circuit; reading a potential of a control node of the pixel display circuit via the corresponding data line; and determining whether or not the pixel display circuit is normal based on the read potential.

According to the image display apparatus, a current flowing through the electric field light-emitting element is determined by the potential of the control node and the resistance value of the resistor element. The potential of the control node is set to the potential equal to that of the data line by the differential amplifier circuit and the offset compensation circuit. Accordingly, the factor of variations of the value of the current flowing through the electric field light-emitting element becomes only the resistance value of the resistor element. Since the variations of resistance value of the resistor element is smaller than that of characteristics (threshold value, mobility) of transistors, variations of display characteristics among pixels are reduced as compared to conventional technique. Additionally, as the differential amplifier circuit and the offset compensation circuit are activated when a corresponding row is selected by the vertical scanning circuit, current consumption becomes small.

Additionally, the inspection method of the image display apparatus according to the present invention includes the steps of: providing a data line corresponding to a pixel display circuit of an inspection target with a test potential; activating a differential amplifier circuit and an offset compensation circuit of the pixel display circuit; reading a potential of the control node of the pixel display circuit via the corresponding data line; and determining whether or not the pixel display circuit is normal based on the read potential. Accordingly, the pixel display circuit can be electrically inspected without inspecting the optical characteristics of the electric field light-emitting element, whereby the inspection costs can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of an EL display apparatus according to a first embodiment of the present invention.

FIG. 2 is a block diagram showing a configuration of a pixel display circuit shown in FIG. 1.

FIG. 3 is a circuit diagram showing a configuration of the pixel display circuit shown in FIG. 2.

FIG. 4 is a timing chart showing an operation of the pixel display circuit shown in FIG. 3:

FIG. 5 is a circuit diagram showing a modification of the first embodiment.

FIG. 6 is a circuit diagram showing another modification of the first embodiment.

FIG. 7 is a circuit diagram showing still another modification of the first embodiment.

FIG. 8 is a circuit diagram showing still another modification of the first embodiment.

FIG. 9 is a circuit diagram showing still another modification of the first embodiment.

FIG. 10 is a circuit diagram showing still another modification of the first embodiment.

FIG. 11 is a circuit diagram showing still another modification of the first embodiment.

FIG. 12 is a circuit diagram showing a configuration of a pixel display circuit included in an EL display apparatus according to a second embodiment of the present invention.

FIG. 13 is a circuit diagram showing a modification of the second embodiment.

FIG. 14 is a circuit diagram showing another modification of the second embodiment.

FIG. 15 is a circuit diagram showing a configuration of a pixel display circuit included in an EL display apparatus according to a third embodiment of the present invention.

FIG. 16 is a circuit diagram showing a modification of the third embodiment.

FIG. 17 is a circuit diagram showing another modification of the third embodiment.

FIG. 18 is a block diagram showing a configuration of a pixel display circuit included in an EL display apparatus according to a fourth embodiment of the present invention.

FIG. 19 is a circuit diagram showing a configuration of a pixel display circuit shown in FIG. 18.

FIG. 20 is a circuit diagram showing a modification of the fourth embodiment.

FIG. 21 is a circuit diagram showing another modification of the fourth embodiment.

FIG. 22 is a circuit diagram showing still another modification of the fourth embodiment.

FIG. 23 is a circuit diagram showing a configuration of a pixel display circuit included in an EL display apparatus according to a fifth embodiment of the present invention.

FIG. 24 is a timing chart showing an operation of the pixel display circuit shown in FIG. 23.

FIG. 25 is a circuit diagram showing a modification of the fifth embodiment.

FIG. 26 is a circuit diagram showing an inspection method of a pixel display circuit according to a sixth embodiment of the present invention.

### DESCRIPTION OF THE PREFERRED EMBODIMENTS

### First Embodiment

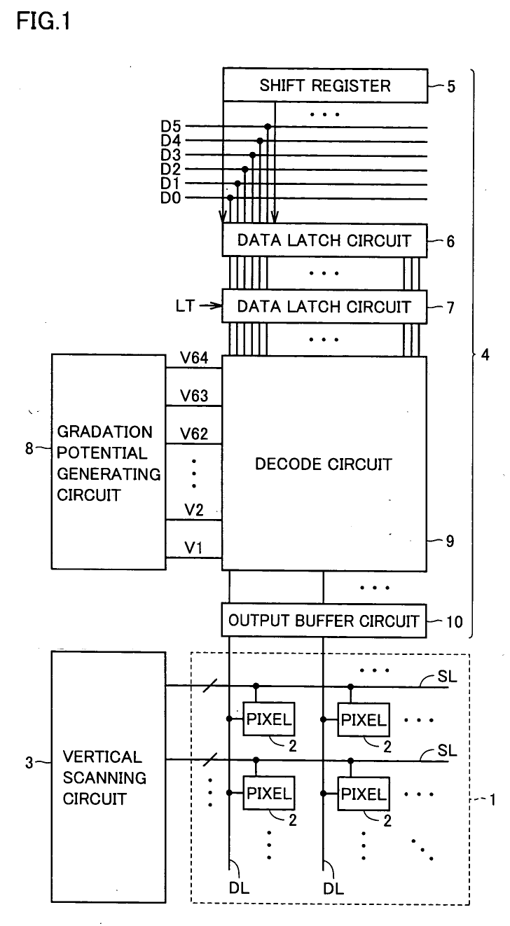

FIG. 1 is a block diagram showing a configuration of an EL display apparatus according to a first embodiment of the present invention. Referring to FIG. 1, this EL display apparatus includes a pixel array 1, a vertical scanning circuit 3 and a horizontal scanning circuit 4. Pixel array 1, vertical scanning circuit 3 and horizontal scanning circuit 4 may be arranged on one substrate, or part of or all of vertical scanning circuit 3 and horizontal scanning circuit 4 may be arranged as external circuitry.

Pixel array 1 includes a plurality of pixel display circuits 2 arranged in a plurality of rows and columns, a plurality of data lines DL provided corresponding to the plurality of columns, respectively, and a plurality of signal lines SL provided corresponding to each of the plurality of rows. Each pixel display circuit 2 has an EL element, and controlled by a plurality of control signals provided through a plurality of corresponding signal lines SL, and emits light at a light intensity according to a potential provided through a corresponding data line DL. Pixel display circuit 2 will be described in detail later.

Vertical scanning circuit 3, which operates synchronizing with an image signal, successively selects a plurality of rows each for one horizontal period, and controls each pixel display circuit 2 through respective signal lines SL of the selected row to cause each pixel display circuit 2 to retain the potential of a corresponding data line DL.

Horizontal scanning circuit 4 provides each data line DL with a potential according to an image signal while one row is selected by vertical scanning circuit 3. The image signal includes a plurality of bits, for example 6 bits, of data signals D0-D5. Data signals D0-D5 are serially generated corresponding to each pixel display circuit 2. By 6-bit data signals D0-D5, gradation display in 2⁶=64 stages is achieved in each pixel display circuit 2. Furthermore, forming one color display unit with three pixel display circuits 2 of R (Red), G (Green), and B (Blue), color display in about 260,000 colors is achieved.

Specifically, horizontal scanning circuit 4 includes a shift register 5, data latch circuits 6 and 7, a gradation potential generating circuit 8, a decode circuit 9, and an output buffer circuit 10. Shift register 5 instructs data latch circuit 6 to latch data signals D0-D5, at the timing synchronizing with a prescribed cycle with which setting of data signals D0-D5 is switched. Data latch circuit 6 successively latches serially generated data signals D0-D5 for one row and retains them.

At the timing when data signals D0-D5 for one row are latched by data latch circuit 7, in response to activation of a latch signal LT, a group of data signals D0-D5 latched by data latch circuit 6 is transmitted to data latch circuit 7. Gradation potential generating circuit 8 provides 64-stage gradation potentials V1-V64 to decode circuit 9.

Decode circuit 9, for each column, selects one of the 64 gradation potentials V1-V64 in accordance with data signals D0-D5 latched by data latch circuit 7, and provides output circuit 10 with the selected potential. Output buffer circuit 10, for each column, supplies data line DL with current such that the potential of data line DL becomes equal to the gradation potential provided by decode circuit 9.

When the gradation potential is written to each pixel display circuit 2 of pixel array 1 by vertical scanning circuit 3 and horizontal scanning circuit 4, one image is displayed on pixel array 1.

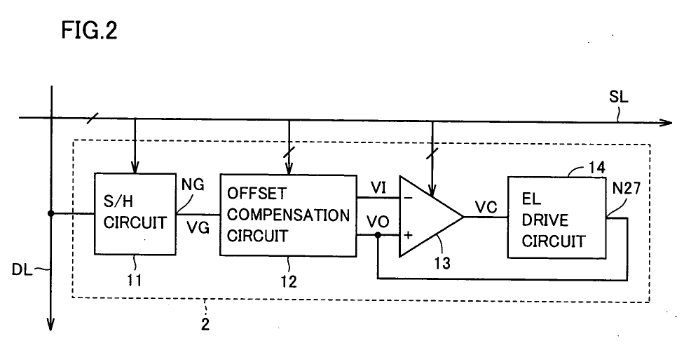

FIG. 2 is a block diagram showing a configuration of pixel display circuit 2. In FIG. 2, pixel display circuit 2 includes a sampling/holding (S/H) circuit 11, an offset compensation circuit 12, a differential amplifier circuit 13, and an EL drive circuit 14. Sampling/holding circuit 11 is controlled by a control signal provided through signal line SL for sampling and holding the potential of corresponding data line DL in a period during which a corresponding row is selected by vertical scanning circuit 3, and providing sampled and held potential VG to offset compensation circuit 12.

Offset compensation circuit 12 is controlled by a plurality of control signals provided through a plurality of signal lines SL, detects an offset voltage VOF of differential amplifier circuit 13 in a period during which differential amplifier circuit 13 is activated, and provides differential amplifier circuit 13 with a potential VI=VG+VOF obtained by adding detected offset voltage VOF to potential VG provided by sampling/holding circuit 11 to cancel offset voltage VOF of differential amplifier circuit 13.

Differential amplifier circuit 13 receives an output potential VI of offset compensation circuit 12 at its inversion input-terminal (−), receives a potential VO of a control node N27 of EL drive circuit 14 at its non-inversion input terminal (+), and has its output terminal connected to EL drive circuit 14. Differential amplifier circuit 13 is activated in response to a plurality of control signals provided through a plurality of signal lines SL, and provides EL drive circuit 14 with a control voltage VC such that potential VO of control node N27 of EL drive circuit 14 becomes equal to potential VI provided by offset compensation circuit 12. EL drive circuit 14 allows current IEL having a value according to control potential VC provided by differential amplifier circuit 13 to flow through the EL element to cause the EL element to emit light.

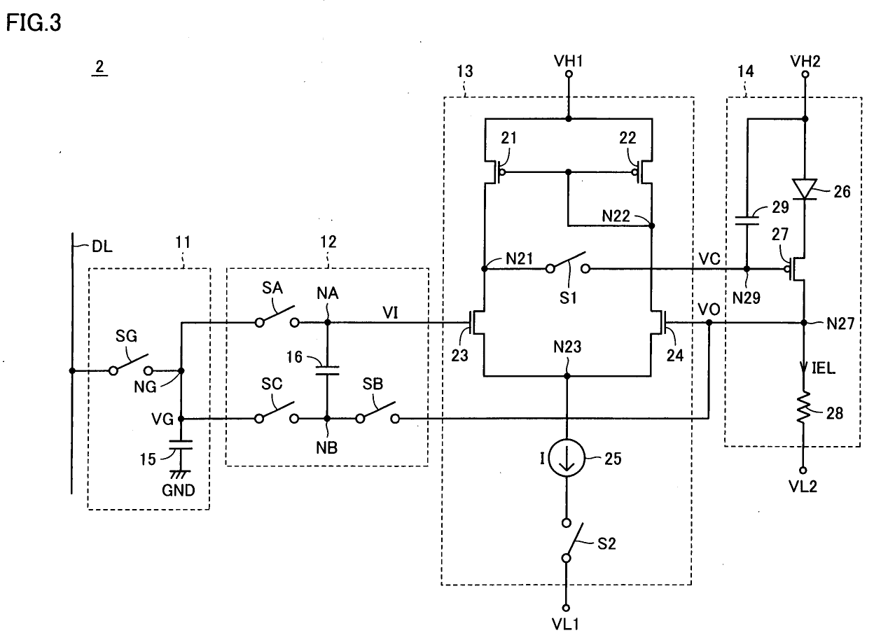

FIG. 3 is a circuit diagram showing a configuration of pixel display circuit 2 in detail. In FIG. 3, sampling/holding circuit 11 includes a switching element SG and a capacitor 15. Switching element SG is connected between data line DL and node NG, and turns on in a period during which a corresponding row is selected by vertical scanning circuit 3. Capacitor 15 is connected between node NG and a line of ground potential GND. When switching element SG turns on, node NG is charged to the same potential VG as data line DL. When switching element SG turns off, potential VG of node NG is retained by capacitor 15.

EL drive circuit 14 includes an EL element 26 and P-type field-effect transistor (hereinafter referred to as a P-type transistor) 27 serially connected between a line of high potential VH2 and control node N27, a resistor element 28 connected between control node N27 and a line of low potential VL2, and a capacitor 29 connected between the line of high potential VH2 and the gate of P-type transistor 27 (node N29). Given that a resistance value of resistor element 28 is R, a current IEL=(V0−VL2)/R, which has the value according to voltage V0-VL2 between potential VO of control node N27 and low potential VL2, flows through EL element 26, P-type transistor 27 and resistor element 28. EL element 26 emits light at a light intensity according to current IEL.

A potential of gate N29 of P-type transistor 27, i.e., control potential VC, is retained by capacitor 29. Though one electrode of capacitor 29 is connected to the line of high potential VH2, it may be connected to other line of a constant potential. Additionally, when a leakage current from node N29 is small, capacitor 29 may be omitted.

Differential amplifier circuit 13 includes P-type transistors 21 and 22, N-type field-effect transistors (hereinafter referred to as N-type transistors) 23 and 24, a constant current source 25, and switching elements S1 and S2. P-type transistors 21 and 22 are connected between the line of high potential VH1 and node N21 and the line of high potential VH1 and node N22, respectively, and both have their gates connected to nodes N22. P-type transistors 21 and 22 form a current mirror circuit. Switching element S1 is connected between node N21 and node N29 of EL drive circuit 14, and turns on in a period during which a corresponding row is selected by vertical scanning circuit 3.

N-type transistors 23 and 24 are connected between nodes N21 and N23 and nodes N22 and N23, respectively, and their gates are connected to nodes NA and N27, respectively. The gates of N-type transistors 23 and 24 form the inversion input terminal and the non-inversion input terminal of differential amplifier circuit 13, respectively. Constant current source 25 and switching element S2 are serially connected between node N23 and the line of low potential VL1. Switching element S2 turns on in a period during which a corresponding row is selected by vertical scanning circuit 3. When switching element S2 turns on, constant current source 25 allows a prescribed constant current to flow from node N23 to the line of low potential VL2.

Switching element S2 is provided for reducing the power consumption, and it may be arranged to any position between the line of high potential VH1 and the line of low potential VL1 as long as it can interrupt a current. For example, switching element S2 may be arranged between node N23 and constant current source 25, or it may be arranged between the line of high potential VH1 and the source of P-type transistors 21 and 22. Additionally, VH1 and VH2, and VL1 and VL2 may have the same potential, respectively.

Next, operations of differential amplifier circuit 13 and EL drive circuit 14 will be described. When switching elements S1 and S2 turn on, differential amplifier circuit 13 is activated. A current having a value according to potential VO of control node N27 flows through N-type transistor 24. As N-type transistor 24 and P-type transistor 22 are serially connected and P-type transistors 22 and 21 form a current mirror circuit, a current having a value according to the current of N-type transistor 24 flows through P-type transistor 21. Through N-type transistor 23, a current having a value according to potential VI of node NA flows.

When VO is higher than VI, the current flowing through P-type transistor 21 becomes greater than that flowing through N-type transistor 23, whereby control potential VC increases, the current flowing through P-type transistor 27 decreases, and potential VO of control node N27 decreases. When VO is lower than VI, the current flowing through P-type transistor 21 becomes smaller than that flowing through N-type transistor 23, whereby control potential VC decreases, the current flowing through P-type transistor 27 increases, and VO increases.

Therefore, if a threshold voltage VTN23 of N-type transistor 23 and a threshold voltage VTN24 of N-type transistor 24 are equal, then VO=VI is attained. On the other hand, if threshold voltage VTN23 of N-type transistor 23 and threshold voltage VTN24 of N-type transistor 24 are not equal, then an offset voltage VOF=VI−VO=VTN23−VTN24 occurs. For example, when VTN23 is higher than VTN24, differential amplifier circuit 13 becomes stable in a state where VO is lower than VI. This offset voltage VOF is compensated by offset compensation circuit 12.

Offset compensation circuit 12 includes switching elements SA-SC and a capacitor 16. Switching element SA is connected between nodes NG and NA, while switching elements SC and SB are serially connected between nodes NG and N27. Capacitor 16 is connected between node NA and node NB located between switching elements SB and SC.

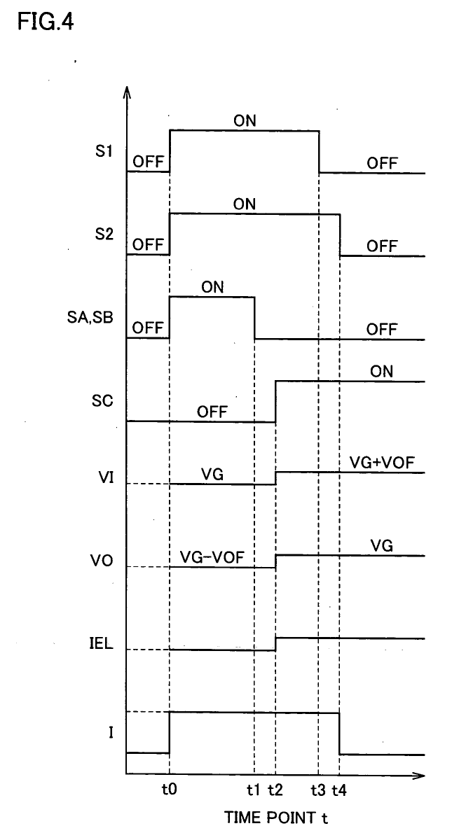

FIG. 4 is a timing chart showing the operation of pixel display circuit 2 shown in FIGS. 1-3. When a corresponding row is selected by vertical scanning circuit 3, switching elements SG, SA-SC, S1, and S2 are controlled to turn on/off by a plurality of control signals provided from vertical scanning circuit 3 through a plurality of signal lines SL of the corresponding row. Switching element SG is caused to turn on when a corresponding row is selected by vertical scanning circuit 3. In FIG. 4, while switching elements S1, S2, SA, and SB are caused to turn on at once for ease of description, it is not necessary to turn them on all at once as long as the operation described below is achieved. Furthermore, an input time point of the potential of data line DL may be before or after time point t0. In FIG. 4, it is assumed that the potential of data line DL is already input.

At time point t0, when switching elements S1, S2, SA, and SB turn on, potential VG of node NG is transmitted to node NA through switching element SA, and therefore VI=VG is attained. Additionally, driving current I flows to activate differential amplifier circuit 13, and potential VO of control node N27 attains VO=VG−VOF. VO is transmitted to node NB through switching element SB. Thus, capacitor 16 is charged to VI−VO=VOF.

After switching elements SA and SB turn off at time point t1, when switching element SC turns on at time point t2, the potential of node NB changes from VG-VOF to VG. This changed amount VOF is transmitted to node NA through capacitor 16, whereby potential VI of node NA attains VI=VG+VOF. As a result, potential VO of control node N27 attains VO=VG, and offset voltage VOF is canceled.

At this time, current IEL=(VG−VL2)/R=(VG/R)−(VL2/R) flows through resistor element 28. If R and VL2 are each determined to be a constant value, then IEL is proportional to VG. Particularly, when VL2 is ground potential GND, IEL=VG/R is attained. If R is set to a prescribed value, IEL can be determined by VG. Hence, the luminance of EL element 26 can be controlled by VG.

Here, the factor of variations of IEL is variations of R. In a conventional technique, two factors, i.e., the threshold voltage and the mobility of a drive transistor, have been the cause of variations of IEL. In contrast, in the present invention, only resistance value R of resistor element 28 becomes the factor of variations of IEL. Accordingly, the number of factors of variations of IEL is reduced as compared to the conventional technique, and hence variations of IEL becomes smaller. It is noted that pixel display circuit 2 is formed on the surface of polycrystalline silicone thin film. Resistance value R of resistor element 28 is adjusted by the amount of ion implantation to the polycrystalline silicone thin film.

Additionally, in an EL display apparatus, the current consumption becomes great since IEL constantly flows. In order to reduce the current consumption of the EL display apparatus, IEL must be decreased. To this end, in a conventional technique, it is necessary to set the voltage between the gate and source of a drive transistor close to the threshold voltage of the drive transistor in order to reduce mutual conductance of the drive transistor. However, IEL becomes more susceptible to the effect of variations of the threshold voltage as the voltage between the gate and source is set closer to the threshold voltage of the drive transistor. Therefore, it has been difficult to reduce the current consumption conventionally. In contrast, according to the present invention, as IEL is reduced by simply increasing resistance value R of resistor element 28, the current consumption can easily be reduced.

Referring back to FIG. 4, at time point t3 when switching element S1 turns off, control potential VC is retained by capacitor 29. At time point t4 when switching element S2 turns off, drive current I is interrupted and differential amplifier circuit 13 is deactivated. This deactivation of differential amplifier circuit 13 is performed since its operation becomes unnecessary as the voltage for causing EL element 26 to emit light is retained by capacitor 29. Since drive current I of differential amplifier circuit 13 only flows in a period during which a corresponding row is selected, increase in the current consumption due to provision of differential amplifier circuit 13 is small.

It is noted that, though it is possible to simultaneously turn switching elements S1 and S2 off, switching element S1 is turned off and thereafter switching element S2 is turned off, as the turning off of switching element S2 can change control potential VC and the changed potential can be retained by capacitor 29.

Additionally, after turning switching element S1 off, charges are leaked from node N29 and potential VC of node N29 decreases as time elapses. The decrease of potential VC in 1 frame time (about 16 msec) does not pose a problem in practice.

In the following, various modifications of the first embodiment will be described. In a modification shown in FIG. 5, EL drive circuit 14 of pixel display circuit 2 is replaced by an EL drive circuit 31. In EL drive circuit 31, capacitor 29 is connected between the gate and the source of P-type transistor 27. This modification achieves the same effect as the first embodiment.

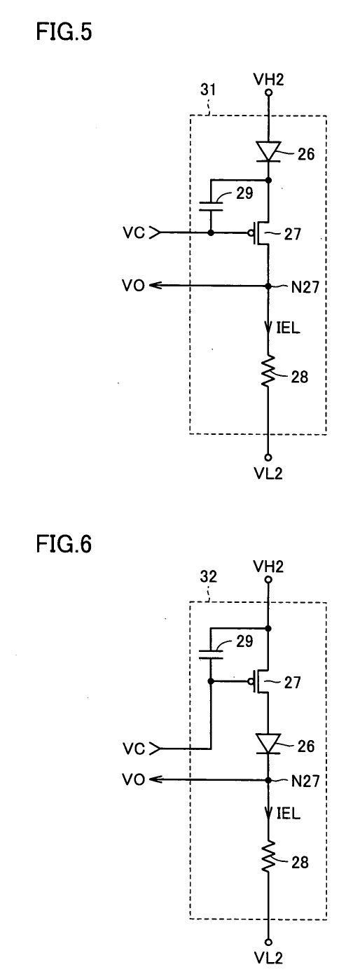

In a modification shown in FIG. 6, EL drive circuit 14 of pixel display circuit 2 is replaced by an EL drive circuit 32. In EL drive circuit 32, P-type transistor 27 and EL element 26 are connected between the line of high potential VH2 and control node N27, and capacitor 29 is connected between the gate and the source of P-type transistor 27. This modification also achieves the same effect as the first embodiment.

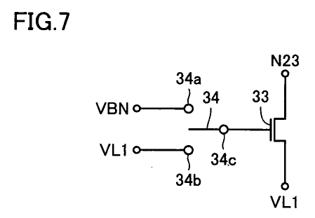

In a modification shown in FIG. 7, constant current source 25 and switching element S2 of FIG. 3 are replaced by N-type transistor 33 and switch 34. N-type transistor 33 is connected between node N23 and the line of low potential VL1, and its gate is connected to a common terminal 34c of switch 34. One terminal 34a of switch 34 receives a bias potential VBN, and the other terminal 34b thereof is connected to the line of low potential VL1. In a period during which switching element S2 of FIG. 3 turns on (time points O-t4 in FIG. 4), switch 34 becomes conductive between its terminals 34a and 34c to provide bias potential VBN to the gate of N-type transistor 33, and N-type transistor 33 operates in a saturation region to cause constant current I to flow. In a period during which switching element S2 of FIG. 3 turns off, switch 34 becomes conductive between its terminals 34b and 34c to provide low potential VL1 to the gate of N-type transistor 33, and N-type transistor 33 turns off. This modification also achieves the same effect as the first embodiment.

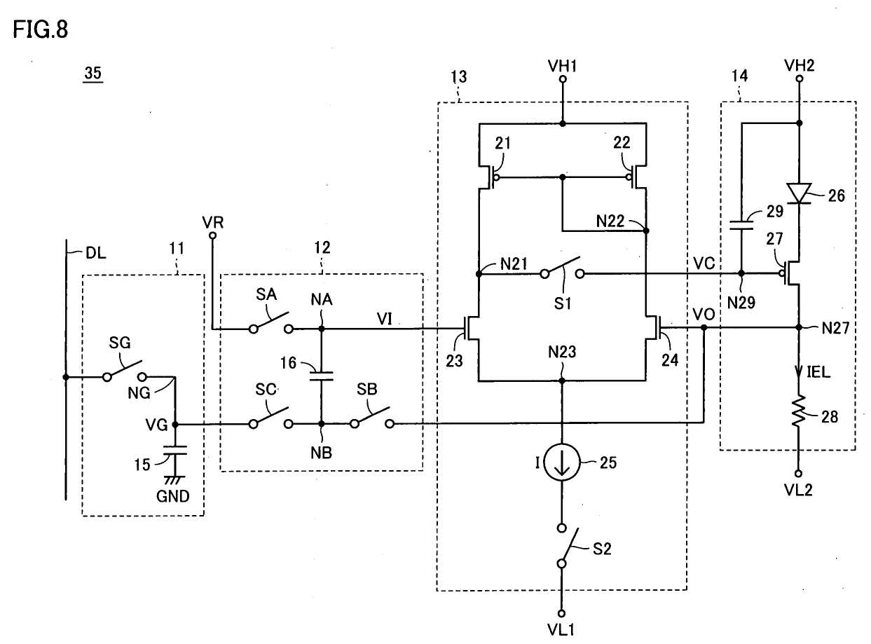

In a modification shown in FIG. 8, pixel display circuit 2 is replaced by a pixel display circuit 35. In pixel display circuit 35, one electrode of switching element SA is connected to the node of reference potential VR instead of node NG. Reference potential VR is supplied from an external or an internal power source with a high current-supplying capability. In this case, as charging of capacitor 16 is performed through the node of reference potential VR, the load of output buffer circuit 10 in FIG. 1 is reduced, whereby acceleration of an offset-canceling operation is achieved.

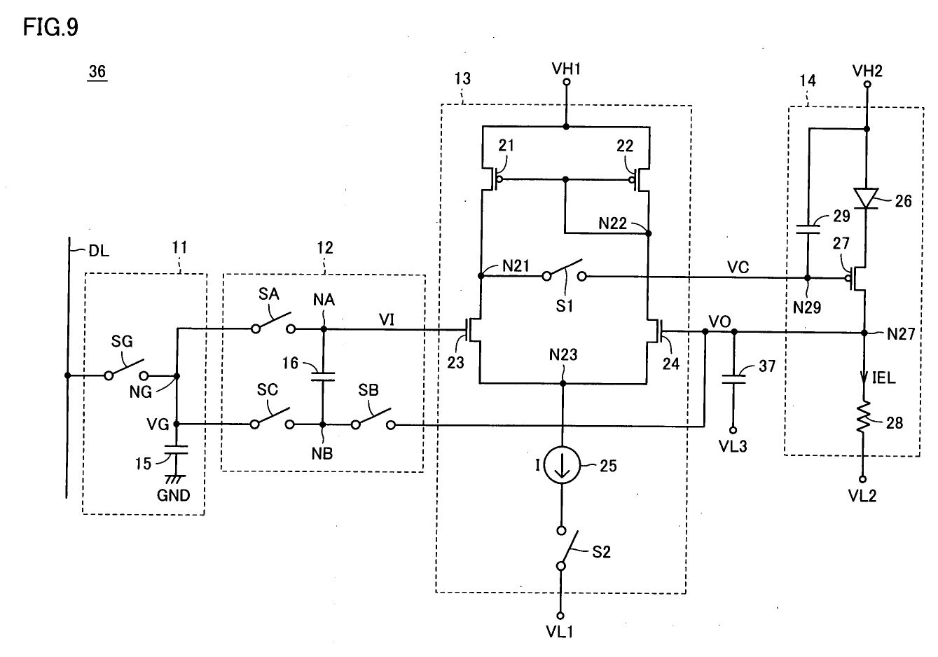

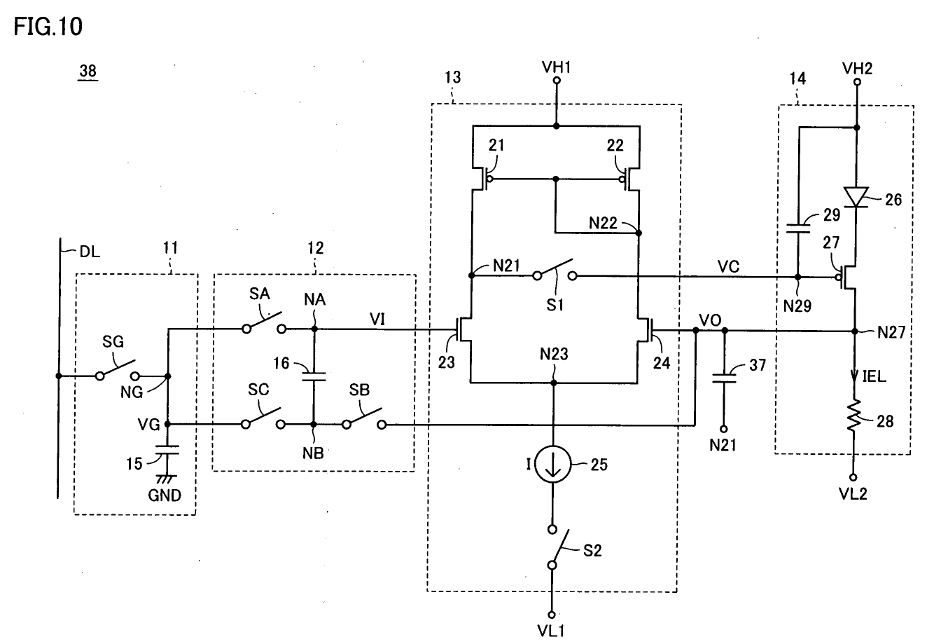

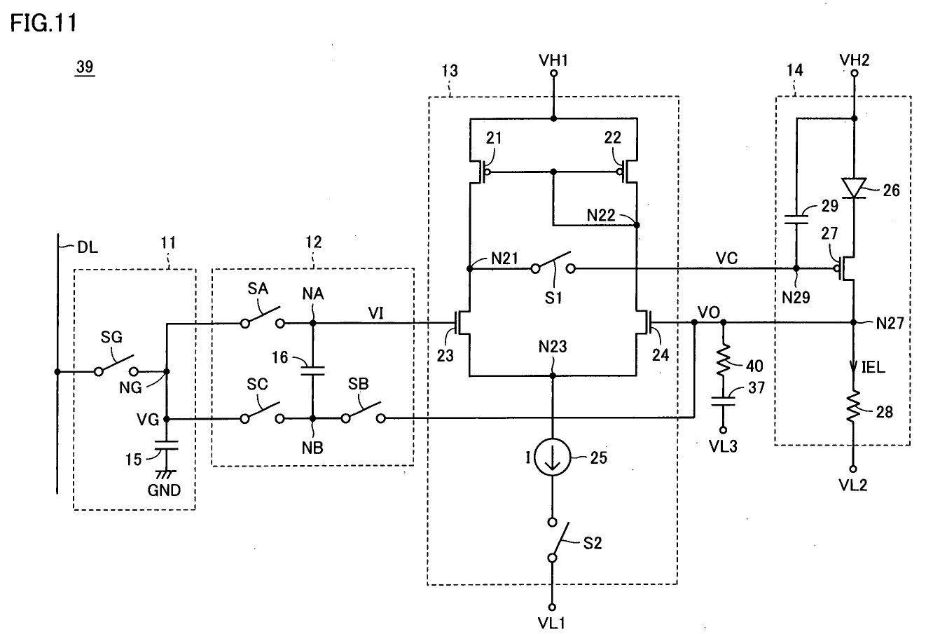

In pixel display circuit 2 of FIG. 3, an oscillation operation may occur as a negative feedback circuit is formed. In order to prevent the oscillation operation, a phase compensation is performed. In pixel display circuit 36 of FIG. 9, a capacitor 37 is connected between control node N27 and the line of low potential VL3 (governing pole compensation method). In pixel display circuit 38 of FIG. 10, one electrode of capacitor 37 is connected to node N21 of differential amplifier circuit 13 instead of the line of low potential VL3 (mirror compensation method). In pixel display circuit 39 of FIG. 11, resistor element 40 and capacitor 37 are connected between control node N27 and the line of low potential VL3 (pole/zero method). With these modifications, the oscillation operation is prevented. Additionally, with pixel display circuit 2 of FIG. 3 also, the oscillation operation is prevented depending on operational conditions.

### Second Embodiment

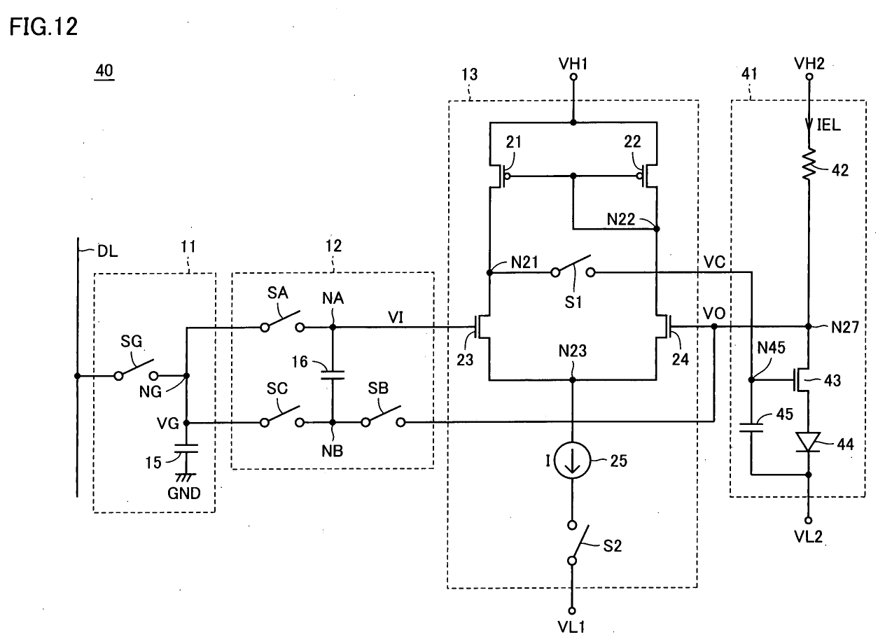

FIG. 12 is a circuit diagram showing a configuration of pixel display circuit 40 included in an EL display apparatus according to a second embodiment of the present invention, in contrast with FIG. 3. Referring to FIG. 12, this pixel display circuit 40 corresponds to pixel display circuit 2 of which EL drive circuit 14 is replaced by an EL drive circuit 41. EL drive circuit 41 includes a resistor element 42 connected between the line of high potential VH2 and control node N27, an N-type transistor 43 and an EL element 44 serially connected between control node 27 and the line of low potential VL2, and a capacitor 45 connected between the gate of N-type transistor 43 and the line of low potential VL2.

Given that a resistance value of resistor element 42 is R, a current IEL=(VH2−VO)/R, which has the value according to voltage VH2−VO between high potential VH2 and potential VO of control node N27, flows through resistor element 42, N-type transistor 43 and EL element 44. EL element 44 emits light at a light intensity according to current IEL.

A potential of the gate (node N45) of N-type transistor 43, i.e., control potential VC, is retained by capacitor 45. Though one electrode of capacitor 45 is connected to the line of low potential VL2, it may be connected to other line of a constant potential. Additionally, when a leakage current from node N45 is small, capacitor 45 may be omitted.

Next, operations of differential amplifier circuit 13 and EL drive circuit 41 are described. When switching elements S1 and S2 turn on, differential amplifier circuit 13 is activated. A current having a value according to potential VO of control node N27 flows through N-type transistor 24. As N-type transistor 24 and P-type transistor 22 are serially connected and P-type transistors 22 and 21 form a current mirror circuit, a current having a value according to the current of N-type transistor 24 flows through P-type transistor 21. Through N-type transistor 23, a current having a value according to potential VI of node NA flows.

When VO is higher than VI, the current flowing through P-type transistor 21 becomes greater than that flowing through N-type transistor 23, whereby control potential VC increases, the current flowing through N-type transistor 43 increases, and potential VO of control node N27 decreases. When VO is lower than VI, the current flowing through P-type transistor 21 becomes smaller than that flowing through N-type transistor 23, whereby control potential VC decreases, the current flowing through N-type transistor 43 decreases, and VO increases.

Therefore, if a threshold voltage VTN23 of N-type transistor 23 and a threshold voltage VTN24 of N-type transistor 24 are equal, then VO=VI is attained. On the other hand, if threshold voltage VTN23 of N-type transistor 23 and threshold voltage VTN24 of N-type transistor 24 are not equal, then an offset voltage VOF=VI−VO=VTN23−VTN24 occurs. For example, when VTN23 is higher than VTN24, differential amplifier circuit 13 becomes stable in a state where VO is lower than VI. This offset voltage VOF is compensated by offset compensation circuit 12.

The second embodiment achieves the same effect as the first embodiment.

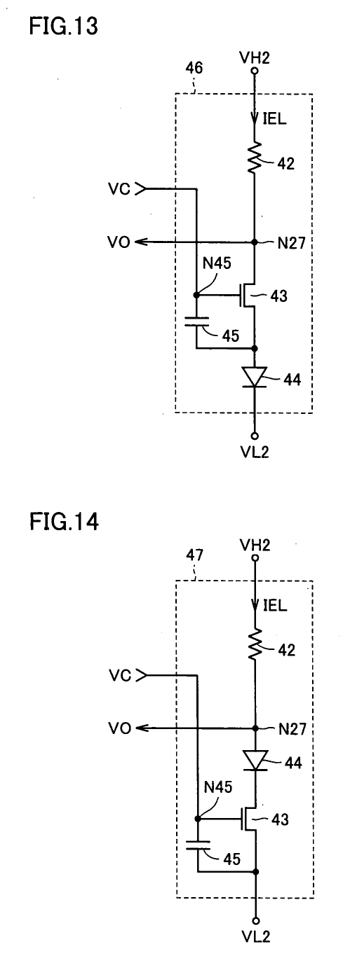

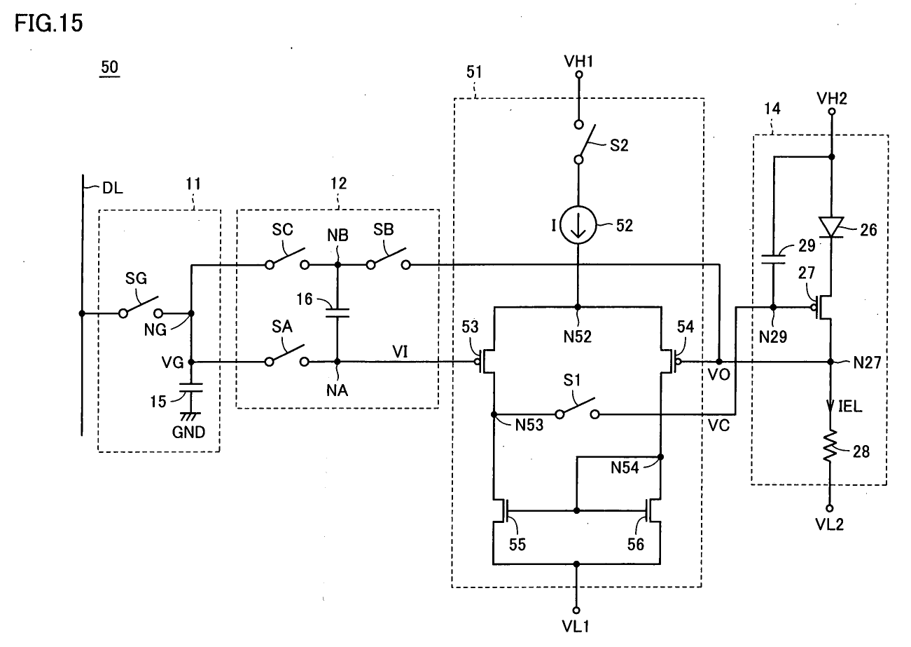

In the following, various modifications of the second embodiment are described. In a modification of FIG. 13, EL drive circuit 41 is replaced by an EL drive circuit 46. In EL drive circuit 46, capacitor 45 is connected between the gate and the source of N-type transistor 43. In a modification of FIG. 14, EL drive circuit 41 is replaced by an EL drive circuit 47. In EL drive circuit 47, EL element 44 and N-type transistor 43 are serially connected between control node N27 and the line of low potential VL2, and capacitor 45 is connected between the gate and the source of N-type transistor 43. These modifications also attain the same effect as the second embodiment.

### Third Embodiment

FIG. 15 is a circuit diagram showing a configuration of pixel display circuit 50 included in an EL display apparatus according to a third embodiment of the present invention, in contrast with FIG. 3. Referring to FIG. 15, this pixel display circuit 50 corresponds to pixel display circuit 2 of which differential amplifier circuit 13 is replaced by a differential amplifier circuit 51.

Differential amplifier circuit 51 includes switching elements S1 and S2, a constant current source 52, P-type transistors 53 and 54, and N-type transistors 55 and 56. Switching element S2 and constant current source 52 are connected between the line of high potential VH1 and node N52. When switching element S2 turns on, constant current source 52 allows a prescribed constant current to flow from the line of high potential VH1 and node N52. P-type transistors 53 and 54 are connected between nodes N52 and N53, and nodes N52 and N54, respectively, and have their gates connected to nodes NA and N27, respectively. The gates of P-type transistors 53 and 54 form an inversion input terminal and a non-inversion input terminal of differential amplifier circuit 51, respectively. Switching element S1 is connected between node N53 and the gate of P-type transistor 27. N-type transistors 55 and 56 are connected between node N53 and the line of low potential VL1, and node N54 and the line of low potential VL1, respectively, and both have their gates connected to node N54. N-type transistors 55 and 56 form a current mirror circuit.

Next, operations of differential amplifier circuit 51 and EL drive circuit 14 are described. A current having a value according to potential VO of control node N27 flows through P-type transistor 54. As P-type transistor 54 and N-type transistor 56 are serially connected and N-type transistors 56 and 55 form a current mirror circuit, a current having a value according to the current of P-type transistor 54 flows through N-type transistor 55. Through P-type transistor 53, a current having a value according to potential VI of node NA flows.

When VO is higher than VI, the current flowing through N-type transistor 55 becomes smaller than that flowing through P-type transistor 53, whereby control potential VC increases, the current flowing through P-type transistor 27 decreases, and VO decreases. When VO is lower than VI, the current flowing through N-type transistor 55 becomes greater than that flowing through P-type transistor 53, whereby control potential VC decreases, the current flowing through P-type transistor 27 increases, and VO increases.

Therefore, if a threshold voltage VTP53 of P-type transistor 53 and a threshold voltage VTP54 of P-type transistor 54 are equal, then VO is equal to VI. On the other hand, if threshold voltage VTP53 of P-type transistor 53 and threshold voltage VTP54 of P-type transistor 54 are not equal, then an offset voltage VOF=VI−VO=|VTP54|−|VTP53| occurs. For example, when |VTP53| is higher than |VTP54|, differential amplifier circuit 51 becomes stable in a state where VO is higher than VI. This offset voltage VOF is compensated by the offset canceling operation described with reference to FIG. 4.

The third embodiment achieves the same effect as the second embodiment.

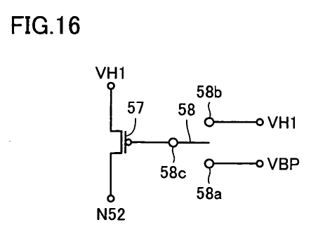

Next, modifications of the third embodiment is described. In a variation shown in FIG. 16, switching element S2 and constant current source 52 of FIG. 5 are replaced by a P-type transistor 57 and a switch 58. P-type transistor 57 is connected between the line of high potential VH1 and node N52, and has its gate connected to a common terminal 58c of switch 58. One terminal 58a of switch 58 receives a bias potential VBP, and the other terminal 58b thereof is connected to the line of high potential VH1. In a period during which switching element S2 of FIG. 15 turns on (time points 0-t4 in FIG. 4), switch 58 becomes conductive between its terminals 58a and 58c to provide bias potential VBP to the gate of P-type transistor 57, and P-type transistor 57 operates in a saturation region to cause constant current I to flow. In a period during which switching element S2 of FIG. 15 turns off, switch 58 becomes conductive between its terminals 58b and 58c to provide high potential VH1 to the gate of P-type transistor 57, and P-type transistor 57 turns off. This modification achieves the same effect as the third embodiment.

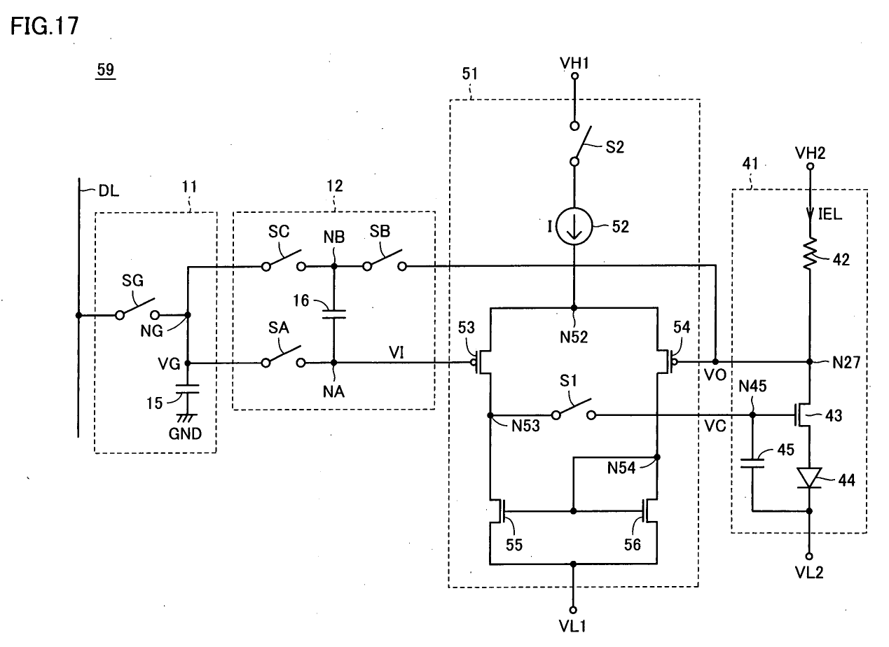

An pixel display circuit 59 shown in FIG. 17 corresponds to pixel display circuit 50 shown in FIG. 15 of which EL drive circuit 14 is replaced by EL drive circuit 41 of FIG. 12. This modification also achieves the same effect as the third embodiment.

### Fourth Embodiment

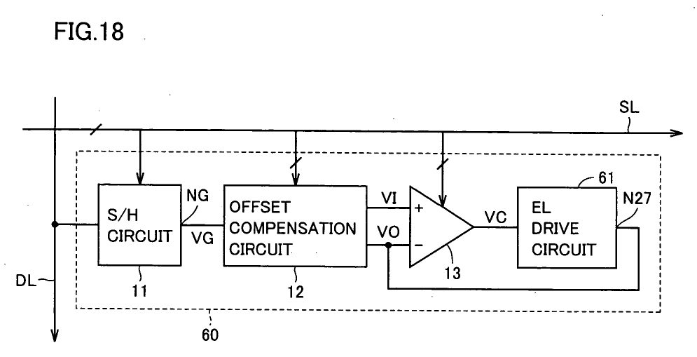

FIG. 18 is a block diagram showing a configuration of pixel display circuit 60 included in an EL display apparatus according to a fourth embodiment of the present invention, in contrast with FIG. 2. Referring to FIG. 18, this pixel display circuit 60 is different from pixel display circuit 2 shown in FIG. 2 in that EL drive circuit 14 is replaced by an EL drive circuit 61, and control node N27 of EL drive circuit 61 is connected to inversion input terminal (−) of differential amplifier circuit 13, and output potential VI of offset compensation circuit 12 is input to non-inversion input terminal (+) of differential amplifier circuit 13.

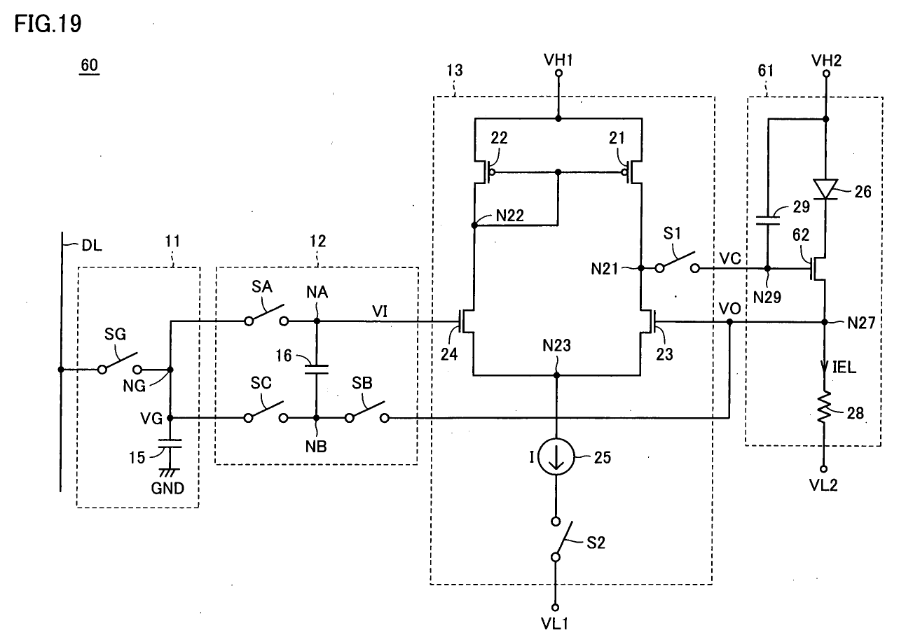

FIG. 19 is a circuit diagram showing a configuration of pixel display circuit 60 shown in FIG. 18 in detail. EL drive circuit 61 corresponds to EL drive circuit 14 of FIG. 3 of which P-type transistor 27 is replaced by an N-type transistor 62. The gate (inversion input terminal) of N-type transistor 23 of differential amplifier circuit 13 is connected to control node N27, the gate (non-inversion input terminal) of N-type transistor 24 is connected to node NA, and node N21 is connected to the gate of N-type transistor 62 via switching element S1.

Next, operations of differential amplifier circuit 13 and EL drive circuit 61 are described. When switching elements S1 and S2 turn on, differential amplifier circuit 13 is activated. A current having a value according to potential VI of node NA flows through N-type transistor 24. As N-type transistor 24 and P-type transistor 22 are serially connected and P-type transistors 22 and 21 form a current mirror circuit, a current having a value according to the current of N-type transistor 24 flows through P-type transistor 21. Through N-type transistor 23, a current having a value according to potential VO of control node N27 flows.

When VO is higher than VI, the current flowing through P-type transistor 21 becomes smaller than that flowing through N-type transistor 23, whereby control potential VC decreases, the current flowing through N-type transistor 62 decreases, and potential VO of control node N27 decreases. When VO is lower than VI, the current flowing through P-type transistor 21 becomes greater than that flowing through N-type transistor 23, whereby control potential VC increases, the current flowing through N-type transistor 62 increases, and VO decreases.

Therefore, if a threshold voltage VTN23 of N-type transistor 23 and a threshold voltage VTN24 of N-type transistor 24 are equal, then VO=VI is attained. On the other hand, if threshold voltage VTN23 of N-type transistor 23 and threshold voltage VTN24 of N-type transistor 24 are not equal, then an offset voltage VOF=VI−VO=VTN24−VTN23 occurs. For example, when VTN24 is higher than VTN23, differential amplifier circuit 13 becomes stable in a state where VO is lower than VI. This offset voltage VOF is compensated by offset compensation circuit 12.

In the fourth embodiment, EL drive circuit 61 is formed as a source-follower circuit using N-type transistor 62, in which the oscillation operation less likely occurs. On the other hand, it is necessary to increase high potential VH1 higher than the configuration shown in FIG. 3 by the threshold voltage of N-type transistor 62. In the present invention, since a current flowing between the line of high potential VH1 and the line of low potential VL1 is interrupted by turning off switching element S2 when a corresponding row is not selected by vertical scanning circuit 3, increase in the current consumption due to increasing high potential VH1 is small.

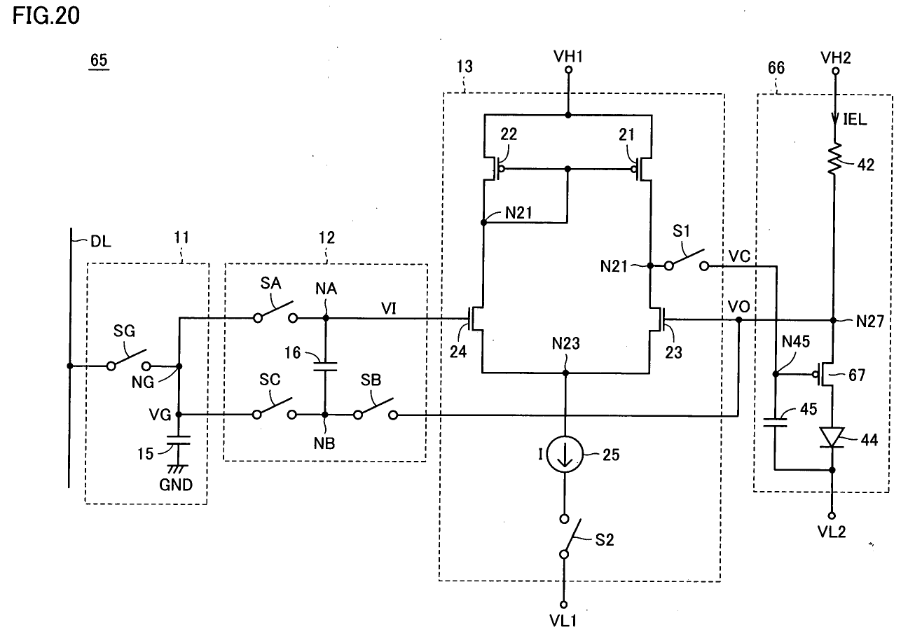

In the following, various modifications of the fourth embodiment are described. Pixel display circuit 65 shown in FIG. 20 corresponds to pixel display circuit 60 shown in FIG. 19 of which EL drive circuit 61 is replaced by an EL drive circuit 66. EL drive circuit 66 corresponds to EL drive circuit 41 of FIG. 12 of which N-type transistor 43 is replaced by a P-type transistor 67.

When VO is higher than VI, the current flowing through P-type transistor 21 becomes smaller than that flowing through N-type transistor 23, whereby control potential VC decreases, the current flowing through P-type transistor 67 increases, and potential VO of control node N27 decreases. When VO is lower than VI, the current flowing through P-type transistor 21 becomes greater than that flowing through N-type transistor 23, whereby control potential VC increases, the current flowing through P-type transistor 67 increases, and VO decreases. Therefore, if a threshold voltage VTN23 of N-type transistor 23 and a threshold voltage VTN24 of N-type transistor 24 are equal, then VO=VI is attained.

In the present modification, EL drive circuit 66 is formed as a source-follower circuit using P-type transistor 67, in which the oscillation operation less likely occurs. On the other hand, it is necessary to decrease low potential VL1 lower than the configuration shown in FIG. 3 by the threshold voltage of P-type transistor 67. In the present invention, since a current flowing between the line of high potential VH1 and the line of low potential VL1 is interrupted by turning off switching element S2 when a corresponding row is not selected by vertical scanning circuit 3, increase in the current consumption due to decreasing low potential VL1 is small.

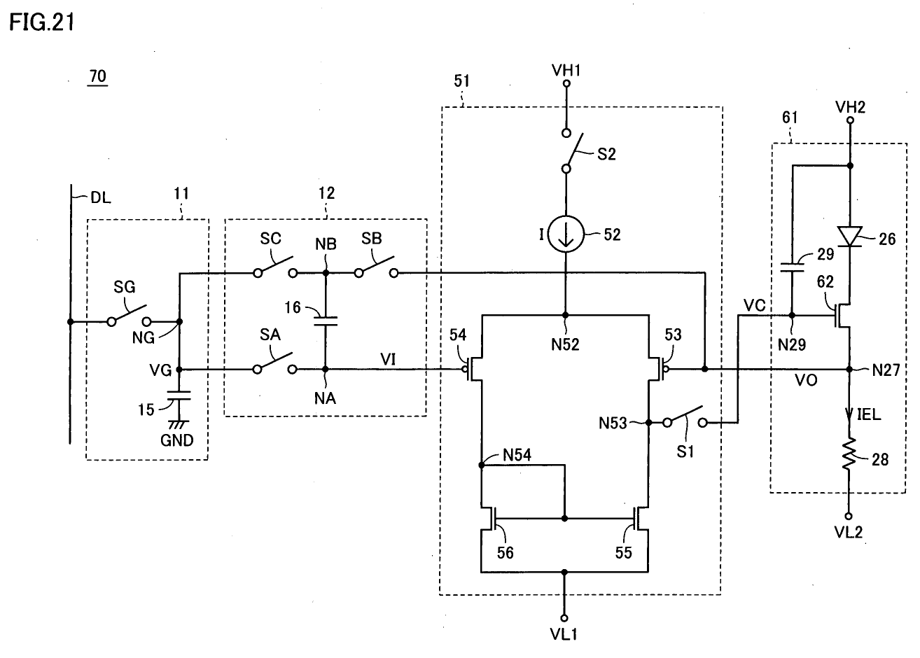

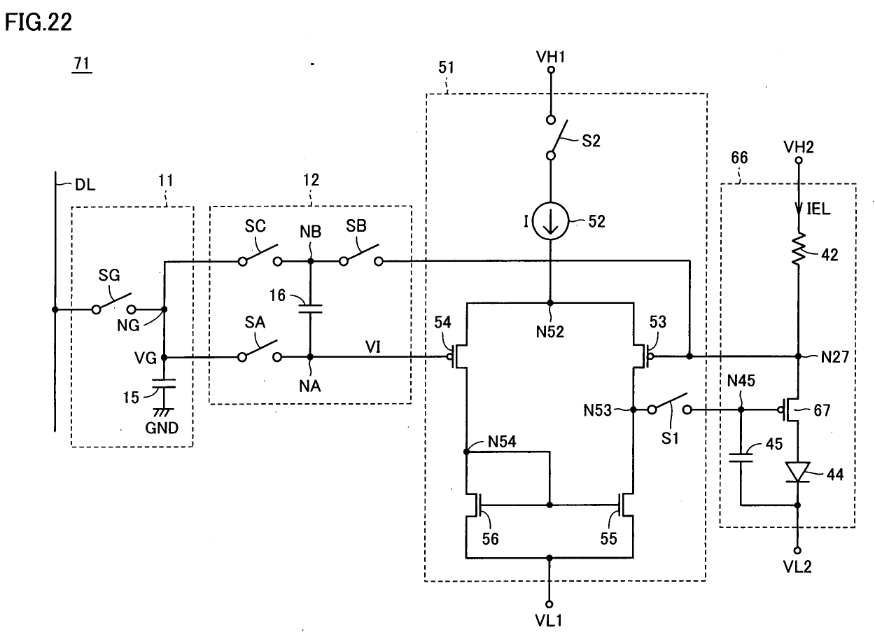

Additionally, a pixel display circuit 70 shown in FIG. 21 corresponds to pixel display circuit 60 shown in FIG. 19 of which differential amplifier circuit 13 is replaced by differential amplifier circuit 51 shown in FIG. 15. A pixel display circuit 71 shown in FIG. 22 corresponds to pixel display circuit 65 shown in FIG. 20 of which differential amplifier circuit 13 is replaced by differential amplifier circuit 51 shown in FIG. 15. With these modification also, the oscillation operation is prevented.

### Fifth Embodiment

In each of the pixel display circuits described above, switching element S1 is actually formed with a N-type transistor, a P-type transistor, or N-type and P-type transistors connected in parallel. There is a problem that control potential VC changes and deviates from a prescribed value due to the parasitic capacitance existing between the gate and the drain of the transistor or between the gate and the source of the transistor when the transistor forming switching element S1 turns off. This changing voltage is referred to as a feedthrough voltage. For example, capacitor 29 shown in FIG. 3 attains a certain effect for reducing the feedthrough voltage, but it is not sufficient. The fifth embodiment is directed to solve this problem.

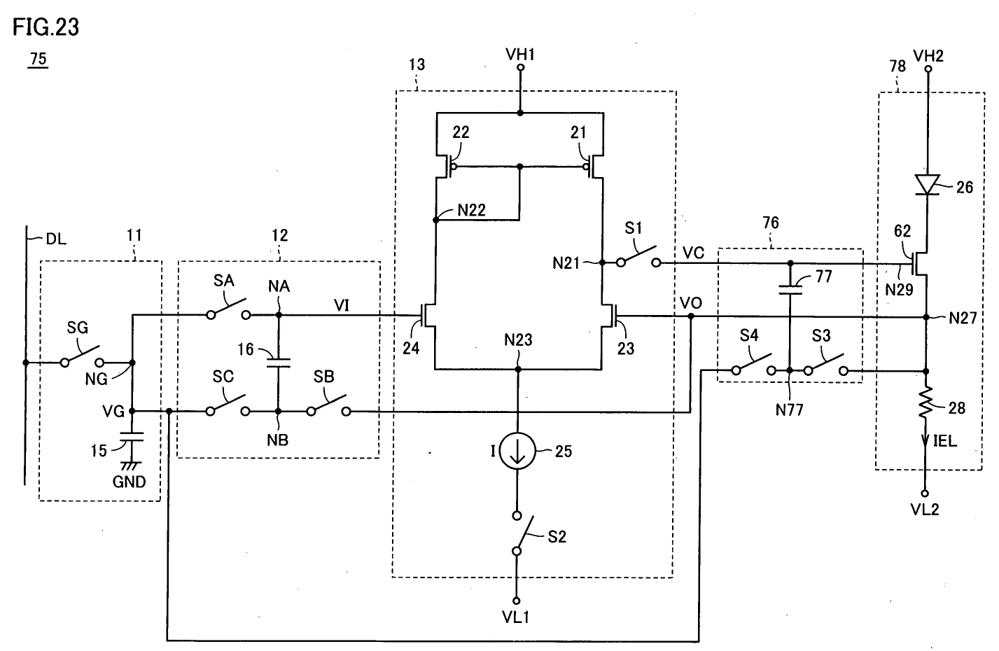

FIG. 23 is a circuit diagram showing a configuration of pixel display circuit 75 included in an EL display apparatus according to the fifth embodiment of the present invention, in contrast with FIG. 19. Referring to FIG. 23, this pixel display circuit 75 is different from pixel display circuit 60 shown in FIG. 19 in that a feedthrough compensation circuit 76 is added and EL drive circuit 61 is replaced by an EL drive circuit 78.

Feedthrough compensation circuit 76 includes switching elements S3 and S4, and capacitor 77. Switching elements S3 and S4 are serially connected between control node N27 and node NG of sampling/holding circuit 11. Switching element S3 is controlled by a control signal provided by vertical scanning circuit 3 through signal line SL, and turns on/off simultaneously with switching element S1. Switching element S4 is controlled by a control signal provided by vertical scanning circuit 3 through signal line SL, and turns on in response to switching elements S1 and S3 turning off Capacitor 77 is connected between the gate of N-type transistor 62 and node N77 located between switching elements S3 and S4. EL drive circuit 78 corresponds to EL drive circuit 61 shown in FIG. 19 from which capacitor 29 is removed.

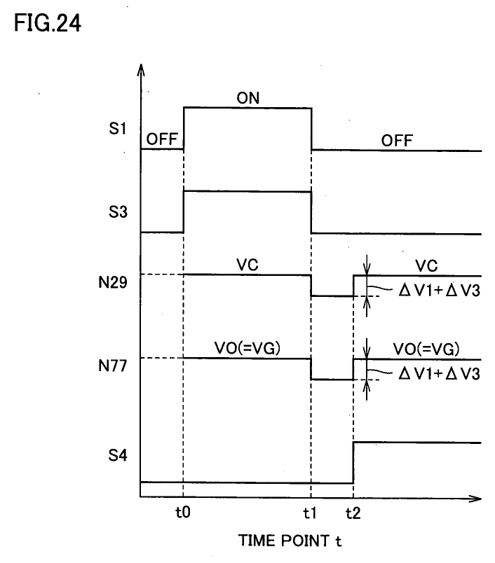

FIG. 24 is a timing chart showing a feedthrough canceling operation. In FIG. 24, at time point t0 switching elements S1 and S3 both turn on, whereby the offset cancel operation described with reference to FIG. 4 is performed, control potential VC is provided to node N29, and VO=VG is provided to nodes N27 and N77.

At time point t1 when switching elements S1 and S3 turn off, a feedthrough voltage occurs due to switching elements S1 and S3. Now, consideration is made only about switching element S1. Given that a feedthrough voltage of −ΔV1 occurs in node N29 due to switching element S1 having turned off, potential VC of node N29 decreases by ΔV1. As the capacitance of capacitor 77 is set to be sufficiently larger than the parasitic capacitance of node N77, substantially 100% of that changed amount is transmitted to node N77 by capacitor 77. Similarly, potential VO=VG of node N77 decreases by ΔV3 due to switching element S3 having turned off, and substantially 100% of that changed amount is transmitted to node N29. Finally, the potential of node N77 decreases from VO=VG by ΔV1+ΔV3. Similarly, the potential of node N29 decreases from VC by ΔV1+ΔV3.

Next, at time point t2 when switching element S4 turns on, the potential of node N77 attains potential VG of node NG that is in a low-impedance state. Specifically, the potential of node N77 increases by ΔV1+ΔV3. This changed amount is transmitted to node N29 through capacitor 77, and the potential of node N29 is returned to VC. Thus, the feedthrough voltage is canceled.

It should be noted that, as one electrode of capacitor 77 is connected to constant potential VG while switching element S4 is on, capacitor 77 serves as a capacitor for retaining the potential of node N29.

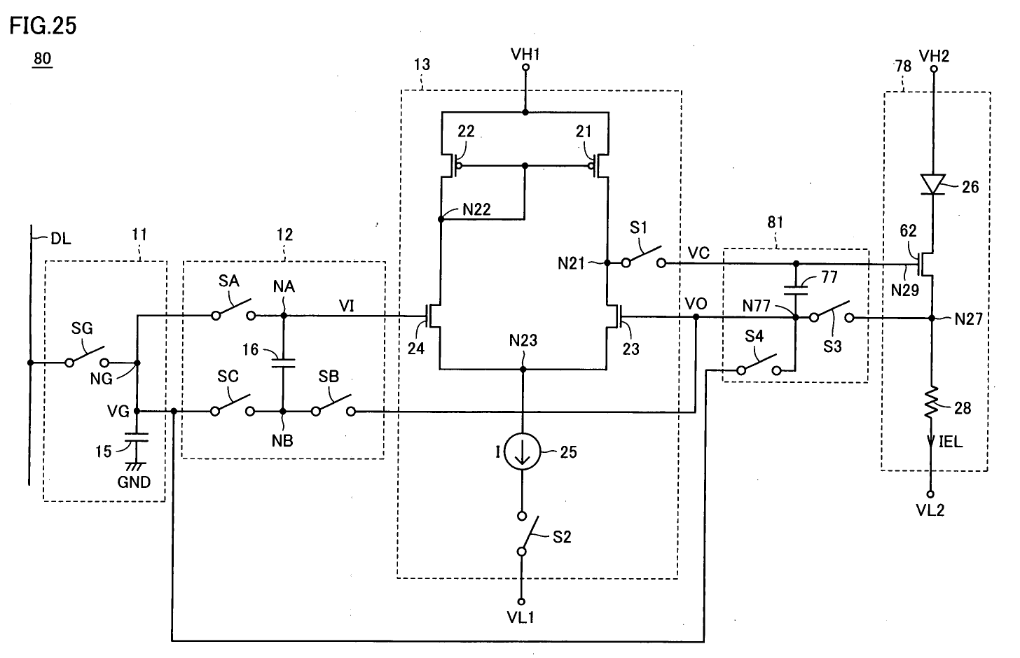

FIG. 25 is a circuit diagram showing a modification of the fifth embodiment of the present invention. This pixel display circuit 80 is different from pixel display circuit 75 shown in FIG. 23 in that feedthrough compensation circuit 76 is replaced by a feedthrough compensation circuit 81. Feedthrough compensation circuit 81 includes switching elements S3 and S4, and capacitor 77. Switching element S3 is connected between the gate of N-type transistor 23 of differential amplifier circuit 13 and control node N27. Switching element S4 is connected between node NG of sampling/holding circuit 11 and the gate of N-type transistor 23. Capacitor 77 is connected between node N29 and node N77 located between switching elements S3 and S4. In this modification, as wiring for the feedback route from EL drive circuit 78 to differential amplifier circuit 13 and wiring for switching element S3 are shared, the occupying area of the circuit is reduced as compared to pixel display circuit 75 shown in FIG. 23. On the other hand, there is a demerit that the gate capacitance of N-type transistor 23 serves as the parasitic capacitance of node N77.

### Sixth Embodiment

When manufacturing the EL display apparatuses of the present invention, yield at the point when assembled as EL display apparatuses (rate of conforming items) is important. The yield of the EL display apparatuses is largely determined by the rate of defects of pixel array 2 having large occupying area. In order to reduce the manufacturing costs of the EL display apparatuses, it is preferable to remove defective items as much as possible at the stage prior to the manufacturing process. Specifically, for reducing the manufacturing-costs, it is more effective to detect defective items by an electric inspection at the stage where the pixel display circuit is formed, than to detect defective items at the stage of optical inspection of displaying characteristics of the EL element having been assembled as an EL display apparatus. In the sixth embodiment, an electric inspection method of the pixel display circuit is described.

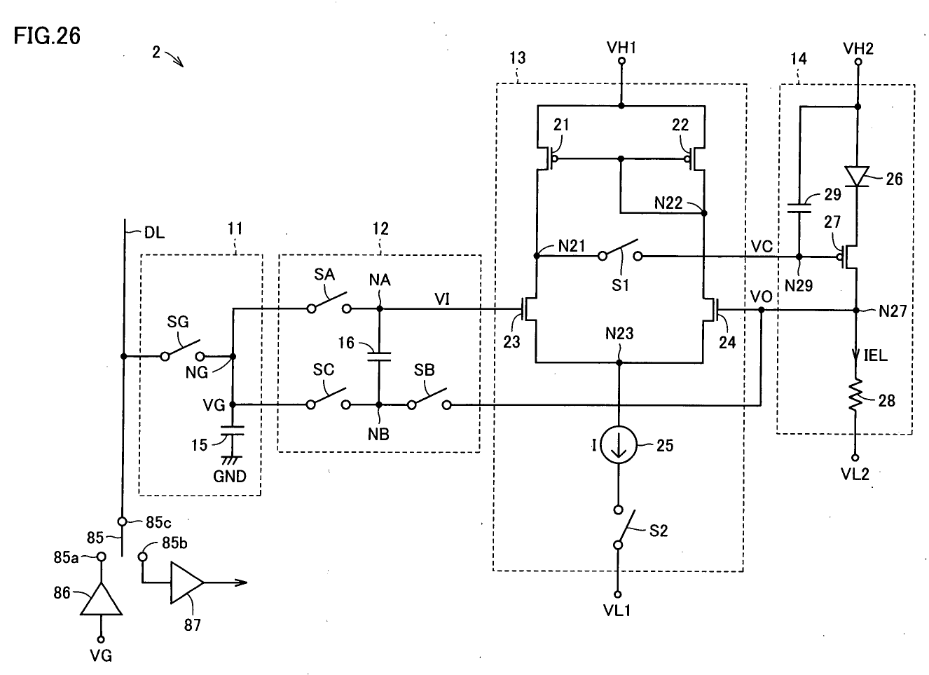

FIG. 26 is a circuit diagram showing an inspection method of pixel display circuit 2 according to the sixth embodiment of the present invention. In FIG. 26, with the inspection method, a switch 85, a write driver 86, and a sense amplifier 87 are used. A common terminal of switch 85 is connected to data line DL, while one end 85a thereof is connected to output node of write driver 86 and the other terminal thereof is connected to sense amplifier 87.

First, switching elements SG, SA, SB, S1 and S2 are turned on, and switching element SC is turned off. Switch 85 is made conductive between its terminals 85a and 85c, to apply prescribed potential VG to an input node of write driver 86. As a result, VI=VG, VO=VI−VOF is attained.

Next, switching elements SA and SB are turned off to retain potential VI=VG of node NA. Next, when switching element SC is turned on, the potential of node NB changes by VOF, whereby potential VI of node NA attains VI=VG+VOF. As a result, VO=VG is attained. Next, switching elements S1 and S2 are successively turned off The operation above is the same as the operation described with reference to FIG. 4. It should be noted that switching element S2 is maintained on.

Next, a potential that is different from VG (for example, ground potential GND) is applied to the input node of write driver 86 such that potential of data line DL is set to a potential different from VG. Thereafter, switch 85 is made conductive between its terminals 85b and 85c, to connect data line DL to the input node of sense amplifier 87.

Next, switching element SB is turned on. As a result, potential VO of control node N27 is transmitted to data line DL. This potential VO is read by sense amplifier 87, and pixel display circuit 2 is determined as normal when VO=VG, and pixel display circuit 2 is determined as defective when VO#VG.

Though potential VO of control node N27 is read in the sixth embodiment, alternatively, a current flowing into data line DL from control node N27 may be detected and whether or not pixel display circuit 2 is conforming may be determined based on the detection result. Further, other various inspection methods are possible by combinations of on/off of switching elements SG, SA, SB, SC, S1 and S2.

Although the present invention has been described and illustrated in detail, it is clearly understood that the same is by way of illustration and example only and is not to be taken by way of limitation, the spirit and scope of the present invention being limited only by the terms of the appended claims.

1. An image display apparatus displaying an image in accordance with an image signal, comprising:
a plurality of pixel display circuits arranged in a plurality of rows and columns and each including an electric field light-emitting element;
a plurality of data lines provided corresponding to said plurality of columns, respectively;
a vertical scanning circuit successively selecting said plurality of rows each for a prescribed time period synchronizing with said image signal; and
a horizontal scanning circuit providing each of said plurality of data lines with a potential according to said image signal while one row is selected by said vertical scanning circuit; wherein
each of said pixel display circuits includes
a drive circuit including a first transistor serially connected to a corresponding electric field light-emitting element between a line of a first potential and a control node, and a resistor element connected between said control node and a line of a second potential, and allowing a current having a value according to a potential of said control node to flow through the corresponding electric field light-emitting element,
a differential amplifier circuit activated in accordance with a selection of a corresponding row by said vertical scanning circuit and setting a potential of a control electrode of said first transistor to allow a potential of said control node to be equal to a potential of an input node, and
an offset compensation circuit activated in a time period during which said differential amplifier circuit is activated to detect an offset voltage of said differential amplifier circuit, providing the input node of said differential amplifier circuit with a potential obtained by adding the detected offset voltage to a potential of a corresponding data line, and canceling the offset voltage of said differential amplifier circuit.

2. The image display apparatus according to claim 1, wherein
said differential amplifier circuit includes
a second transistor receiving the potential of said input node at its control electrode,
a third transistor receiving the potential of said control node at its control electrode, and having its first electrode connected to a first electrode of said second transistor,
a current source activated in a time period during which a corresponding row is selected by said vertical scanning circuit, and allowing a current to flow through said second and third transistors, and
a first switching element connected between a second electrode of said second transistor and the control electrode of said first transistor, and made conductive in a time period during which said current source is activated.

3. The image display apparatus according to claim 2, wherein
said current source includes
a constant current source allowing a prescribed current to flow, and
a second switching element serially connected to said constant current source, made conductive in a time period during which a corresponding row is selected by said vertical scanning circuit, and allowing the current of said constant current source to flow through said second and third transistors.

4. The image display apparatus according to claim 2, wherein
said current source includes
a fourth transistor having its first electrode connected to the first electrodes of said second and third transistors, and
a first switching circuit switching a voltage between a control electrode and a second electrode of said fourth transistor to allow a prescribed current to flow through said fourth transistor in a time period during which a corresponding row is selected by said vertical scanning circuit and to make said fourth transistor non-conductive except for said time period.

5. The image display apparatus according to claim 2, wherein
each of said pixel display circuits further includes a feedthrough compensation circuit compensating for potential variation occurring in said control node when said first switching element is made non-conductive, such that the potential of said control node returns to a potential of a time point immediately before said first switching element was made non-conductive.

6. The image display apparatus according to claim 5, wherein
said feedthrough compensation circuit includes
a first capacitor having its one electrode connected to the control electrode of said first transistor,
a third switching element connected between the other electrode of said first capacitor and said control node and made conductive and non-conductive at a same timing as said first switching element, and
a fourth switching element receiving a potential of a corresponding data line at its one electrode, having its the other electrode connected to said other electrode of said first capacitor, and made conductive in accordance with said third switching element made non-conductive.

7. The image display apparatus according to claim 6, wherein
each of said pixel display circuits further includes
a second capacitor having its one electrode connected to said one electrode of said fourth switching element and receiving a third potential at its the other electrode, and
a fifth switching element connected between a corresponding data line and said one electrode of said second capacitor, and made conductive in a time period during which a corresponding row is selected by said vertical scanning circuit to charge said one electrode of said second capacitor to a potential of the corresponding data line.

8. The image display apparatus according to claim 1, wherein
said differential amplifier circuit includes
a second transistor receiving the potential of said input node at its control electrode,
a third transistor receiving the potential of said control node at its control electrode and having its first electrode connected to a first electrode of said second transistor,
a current source activated in a time period during which a corresponding row is selected by said vertical scanning circuit, and allowing a current to flow through said second and third transistors, and
a first switching element connected between a second electrode of said third transistor and said control electrode of the first transistor, and made conductive in a time period during which said current source is activated.

9. The image display apparatus according to claim 8, wherein
said current source includes
a constant current source allowing a prescribed current to flow, and
a second switching element serially connected to said constant current source, made conductive in a time period during which a corresponding row is selected by said vertical scanning circuit, and allowing the current of said constant current source to flow through said second and third transistors.

10. The image display apparatus according to claim 8, wherein
said current source includes
a fourth transistor having its first electrode connected to the first electrodes of said second and third transistors, and
a first switching circuit switching a voltage between a control electrode and a second electrode of said fourth transistor to allow a prescribed current to flow through said fourth transistor in a time period during which a corresponding row is selected by said vertical scanning circuit and to make said fourth transistor non-conductive except for said time period.

11. The image display apparatus according to claim 8, wherein
each of said pixel display circuits further includes a feedthrough compensation circuit compensating for potential variation occurring in said control node when said first switching element is made non-conductive, such that the potential of said control node returns to a potential of a time point immediately before said first switching element was made non-conductive.

12. The image display apparatus according to claim 111, wherein
said feedthrough compensation circuit includes
a first capacitor having its one electrode connected to the control electrode of said first transistor,
a third switching element connected between the other electrode of said first capacitor and said control node and made conductive and non-conductive at a same timing as said first switching element, and
a fourth switching element receiving a potential of a corresponding data line at its one electrode, having its the other electrode connected to said other electrode of said first capacitor, and made conductive in accordance with said third switching element made non-conductive.

13. The image display apparatus according to claim 12, wherein
each of said pixel display circuits further includes
a second capacitor having its one electrode connected to said one electrode of said fourth switching element and receiving a third potential at its the other electrode, and
a fifth switching element connected between a corresponding data line and said one electrode of said second capacitor, and made conductive in a time period during which a corresponding row is selected by said vertical scanning circuit to charge said one electrode of said second capacitor to a potential of the corresponding data line.

14. The image display apparatus according to claim 1, wherein
each of said pixel display circuits further includes
a phase compensation circuit, having a third capacitor receiving a potential of said control node at its one electrode, for preventing an oscillation operation of said differential amplifier circuit.

15. The image display apparatus according to claim 1, wherein
said offset compensation circuit includes
a fourth capacitor having its one electrode connected to the input node of said differential amplifier circuit,
a second switching circuit providing, in a first time period, said input node with a prescribed potential and connecting the other electrode of said fourth capacitor to said control node to charge said fourth capacitor to the offset voltage of said differential amplifier circuit, and
a third switching circuit providing, in a second time period after said first time period, said other electrode of said fourth capacitor with a potential of a corresponding data line and providing the input node of said differential amplifier circuit with a potential obtained by adding said offset voltage to the potential of the corresponding data line.

16. The image display apparatus according to claim 15, wherein
said prescribed potential is the potential of the corresponding data line.

17. The image display apparatus according to claim 15, wherein
said prescribed potential is a constant reference potential.

18. The image display apparatus according to claim 1, wherein
said drive circuit further includes a fifth capacitor having its one electrode connected to the control electrode of said first transistor to retain a potential of the control electrode of said first transistor.

19. The image display apparatus according to claim 1, wherein
said first transistor and said resistor element are formed with polycrystalline silicon thin films.

20. An inspection method for inspecting the image display apparatus according to claim 1, comprising the steps of:
providing a data line corresponding to a pixel display circuit of an inspection target with a test potential;
activating a differential amplifier circuit and an offset compensation circuit of said pixel display circuit;
reading a potential of a control node of said pixel display circuit through the corresponding data line; and
determining whether or not said pixel display circuit is normal based on the read potential.
